(19) United States
(12) Patent Application Publication
(10) Pub. No.: US 2004/0098380 A1
(43) Pub. Date: May 20, 2004

(54) Method, system and apparatus for providing a search system

(76) Inventors: Stephen D. Dentel, Vancouver, WA (US); Donald J. Welch, Vancouver, WA (US); Douglas DePrenger, Washington, IL (US)

Correspondence Address: HEWLETT-PACKARD COMPANY, Intellectual Property Administration, P.O. Box 272400, Fort Collins, CO, 80527-2400, US

(21) Appl. No.: 10/299,328

(22) Filed: Nov. 19, 2002

(51) Int. Cl. G06F 17/30

(52) U.S. Cl. 707/3

(57) ABSTRACT

The present invention includes as one embodiment a method of providing a complementary user-friendly search system with a document including parsing the document for keywords that are to be included in an index of words in the document, associating each keyword with at least one synonym, the synonym being at lease one common word used by users that relates to the keyword and incorporating the keyword and the at least one synonym in the search system.

### BACKGROUND OF THE INVENTION

When a product is sold to a customer, it is customarily accompanied with product documentation. Product documentation generally contains information regarding proper installation and maintenance of the product as well as instructions on how to efficiently use the product etc. Poorly formatted product documentation, however, may affect the marketability of the product. Specifically, poor product documentation may produce an unacceptably high return rate, high support cost and bad reviews of the product. To ensure that useful and usable product documentations are provided to customers, product manufacturers have typically included detailed tables of contents and indexes in the documentations.

However, creating a detailed table of contents and indexes is usually a time-intensive manual process. Further, since the table of contents and indexes are created manually, they are therefore prone to errors. Additionally, the table of contents and indexes may be difficult to keep up-to-date.

To provide an easy method of updating product documentations, manufacturers have started to provide them electronically. The electronic product documentations may be placed on a distribution media (e.g., CD-ROM or posted on an Internet website). Typically, updates to the documentation are made by updating the Internet website or producing a new updated CD.

Nevertheless, even with electronic product documentation with indexes and tables of contents that are updated, if they do not contain a particular search criteria or a term that a user is interested in, the user may have to read irrelevant or a multiplicity of sections in the documentation. This can be a frustrating endeavor.

### SUMMARY OF THE INVENTION

The present invention includes as one embodiment a method of providing a complementary user-friendly search system with a document including parsing the document for keywords that are to be included in an index of words in the document, associating each keyword with at least one synonym, the synonym being at lease one common word used by users that relates to the keyword and incorporating the keyword and the at least one synonym in the search system.

### BRIEF DESCRIPTION OF THE DRAWINGS

The present invention can be further understood by reference to the following description and attached drawings that illustrate the preferred embodiments. Other features and advantages will be apparent from the following detailed description of the preferred embodiment, taken in conjunction with the accompanying drawings, which illustrate, by way of example, the principles of the invention.

FIG. 1A is an overview block diagram of one embodiment of the present invention in a single computer environment.

FIG. 1B is an overview block diagram of one embodiment of the present invention in a computer networked environment.

FIG. 2 depicts a sample of function of the index file of one embodiment of the present invention.

FIG. 3 is a flow diagram that may be used to generate an index file of one embodiment of the present invention.

FIG. 4 depicts a sample index file of one embodiment of the present invention.

FIG. 5 shows a flow diagram of a process that may be used to conduct a search in one embodiment of the present invention.

### DETAILED DESCRIPTION OF THE PREFERRED EMBODIMENTS

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### I. Description of the Components and Operation

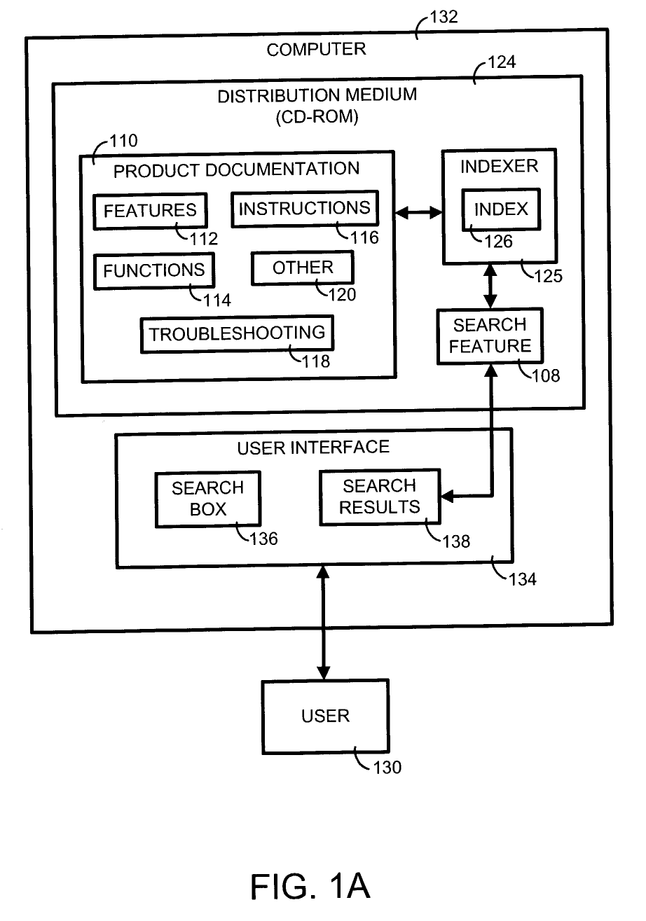

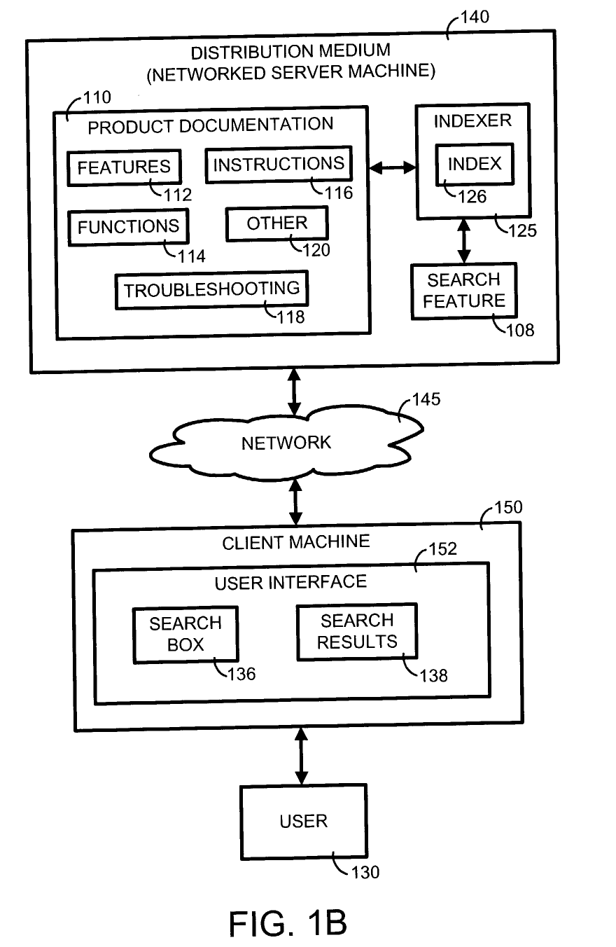

FIG. 1A is an overview block diagram of one embodiment of the present invention in a single computer environment. This embodiment depicts a search engine feature 108 that complements electronic product documentation 110 that is in the form of stored data on a portable computer readable medium, such as a CD-ROM. The product documentation 110 is typically packaged with a product and can contain information regarding the product. For example, the product document 110 may include product feature information 112 product function information 114,, product operational instructions 116, troubleshooting tips for diagnosing problems 118 and other pertinent information 120 relating to the product.

In one embodiment of the present invention, the information contained in the product documentation 110 (features 112, functions 114, operational instructions 116, troubleshooting tips for diagnosing problems 118 and other pertinent information 120) is electronically categorized and organized in a predefined manner within the product documentation 110. Each category can be electronically stored as a separate file on a distribution medium 124, such as a CD-ROM, that is physically provided to a user 130 of the product. Preferably, all of the files are stored into a common directory for easy identification, access and logical organization.

Before the product is distributed, an indexer 125 (shown stored on the distribution medium 124, such as a CD-ROM), parses each file in the common directory to produce an index file 126. In the case where a file is not stored in the common directory, the file may be specifically identified to the parsing program using its pathname. Consequently, the invention is not restricted to having all the files be in the same directory.

The resulting index file 126 may contain keywords, their synonyms and links to relevant topics or related subject matter and the like. The index file 126 is then associated with the product documentation 110 on the distribution medium 124 before public release. The user 130 can use a computer 132 with a user interface 134 or the like to access and read the contents of the of the distribution medium 124.

When the user 130 is interested in obtaining information 112, 114, 116, 118 and 120 relating to the product, the user can access the search engine feature 108 of the product documentation 110 via a search box 136. Upon doing so, the user 130 can enter a term or phrase of interest to be searched in the search box 136. The search box 136 accesses the search engine feature 108 which parses the term or phrase and checks each word to see whether it encompasses a keyword or any one of the keyword's synonyms. If so, the search engine feature 108 returns search results 138 that can include titles of all topics in which the keyword is found, the relative ranking of each topic and a link to each topic.

Updates to the product documentation 110 and the index 126 can be placed on a CD-ROM distribution media and physically mailed to the user 130 or update files can be emailed to the user 130, if the user 130 registered when the product was obtained. For users 130 that do not register or that are not associated with physical or email addresses, the updates can be posted on an Internet website for easy access and optional download. The file size of the updates can be compressed by compression software to reduce the file size and reduce download time.

FIG. 1B shows an alternative embodiment. The distribution medium 140 is, in this embodiment, a networked server machine that is connected to a client machine 150 via a network 145, such as the Internet. The client machine 150 includes a user interface 152 with the search box 136. Similar to the embodiment described above and shown in FIG. 1A, the user can enter a term or phrase of interest to be searched in the search box 136. The search box 136 accesses the search feature 108 which parses the term or phrase and checks each word to see whether it encompasses a keyword or any one of the keyword's synonyms. If so, the search engine feature 108 returns search results 138 that can include titles of all topics in which the keyword is found, the relative ranking of each topic and a link to each topic for display on the user interface 152 of the client machine 150.

### II. Working Example

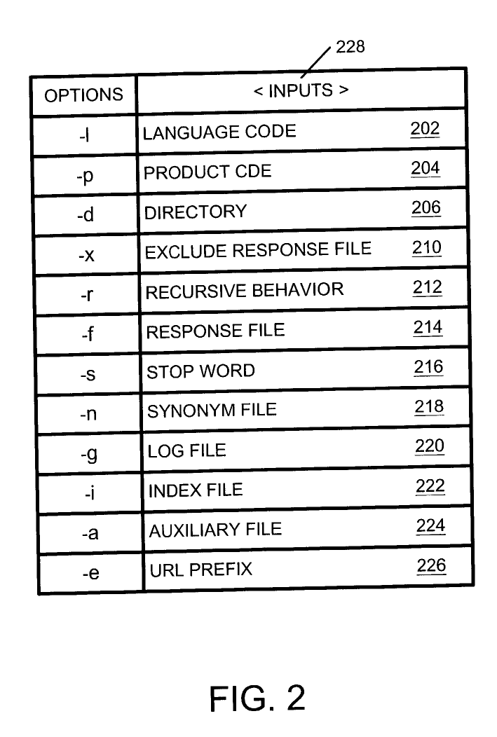

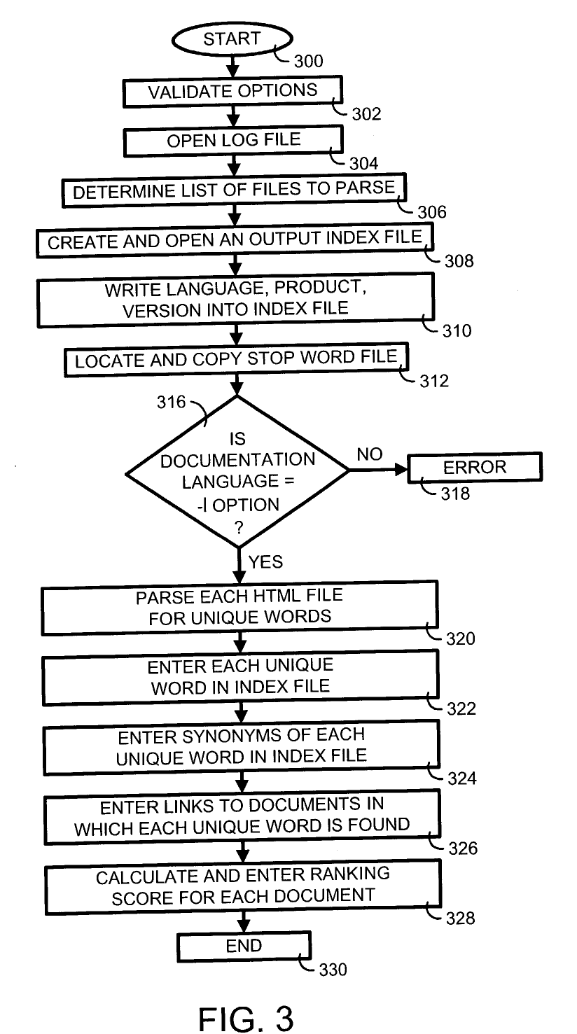

The below description describes a working example of one embodiment of the present invention and is presented for illustrative purposes. FIG. 2 depicts some sample operations of the indexer 125 of one embodiment of the present invention. FIG. 3 is a flow diagram that may be used to generate an index file of one embodiment of the present invention.

### A. The Indexer

Referring to FIG. 1A along with FIG. 2, the indexer 125 is preferably an executable program that can be implemented in any suitable computer language. In one embodiment, the indexer 125 is implemented in C/C++ and runs on a local machine if a CD-ROM is used as the distribution medium or a server if the Internet is used. The indexer 125 is invoked using a command executable file that can be accompanied with some or all of the functions and options shown in FIG. 2.

Attributes of the functions and options are placed between a less than and a greater than sign (< . . . >), as shown in inputs 228 before interpreted by the search feature 108. For example, language code 202 refers to a written language (e.g., English, French, Spanish . . . ) in which the documentation is written. For ease of explanation, English will be used. The code for English is, in this example, “ENU”. Thus, after if the −I option was called, ENU would be placed between a less than and a greater than sign for interpretation by the search feature 108. This option is used to determine which one of a plurality of synonym files are to be used by the search feature 108 (there may be a synonym file for each language).

Other options include a product code option 204, a directory option 206, an exclude response file option 210, a recursive behavior option 212 and a response file option 214. The product code option 204 is used to identify the index file that will be generated as well as to associate the generated index file with the product. The directory 206 option indicates the directory in which the files to be parsed are stored. The exclude response file option 210 identifies a file in the directory that should not be parsed. The recursive behavior option 212 instructs the indexer 125 to parse files that are in subdirectories of directory 206. The response file option 214 is a list of files that are to be parsed. Each line in this file contains a full pathname to a file that is to be included in the index.

Another set of options includes a stop word option 216 that enables the automatic use of a stop word file. Stop words include words such as “the”, “an”, “and”. A synonym file option 218 enables the automatic use of a synonym file. A log file option 220 specifies the log file to use during indexing. An index file option 222 specifies the index file to be generated. An auxiliary file option 224 specifies auxiliary files for the synonym and stop files that are to be used. A URL prefix option 226 specifies the URL prefix for cross-reference sections.

The files that are to be parsed are, in this example, HTML files. In these HTML files, the indexer 125 parses either plain text (i.e., text that will be rendered on a page to the user) or text in special tags. The special tags include all title, META, basic formatting, basic layout and table tags. In this embodiment, unique, non-stop words are indexed. Each HTML document may have a <META> tag. A <META> tag specifies a keyword list for a document. The format of the tag is as follows: <META name=“keywords” content=“<keyword1>, <keyword2>, . . . ” >.

Each indexed keyword and synonym is preferably associated with a predefined number of points related to its importance to a predefined subject matter or location in the document. The points of each occurrence of a word can be determined by the location of the word in each HTML document in which it is found. There are three components to the assigning points to a word: whether the word is found in a <META> tag, <TITLE> tag or in a plain text. If the word is found in a plain text of a document, each occurrence of the word in the document receives, for example, one (1) point toward its importance. As an example, each keyword in a <META> tag can receive 10 ranking points. A <TITLE> tag specifies the title of a document. Each unique, non-stop word that appears in the title of a document receives 5 ranking points.

As such, each HTML document can be ranked based on these points. The document with keywords having the highest number of points will have the highest ranking, and consequently will be listed first when the word is searched by the user. The next highest ranked document will be listed next and so on. If the ranking of two or more documents is equal, the most recent document receives a higher ranking. Although HTML documents are used in the above described embodiment of the present invention, the invention is not restricted to these types of documents. Any other suitable document or markup language may be used.

FIG. 3 is a flow diagram that may be used to generate an index file of one embodiment of the present invention. Referring to FIGS.1-2 along with FIG. 3, the process starts when the indexer 125 is invoked (step 300). Upon the invocation of the indexer 125, all options used at the command line are validated (step 302). That is, a check is made to ensure that all required options are present as well as ensuring that incompatible options are not used in conjunction with each other. For example, the option exclude “response file 210” in FIG. 2 may not appear in conjunction with the option “response file 214”. If this occurs, an error may be generated.

To log the error, a log file may be opened (step 304). The log file is a debugging file that contains detailed information about the operation of the indexer 125. Then, the list of files to be parsed is determined (step 306) and an output index file is created and opened (step 308). The language in which the product documentation (i.e., English, French etc.) is to be presented to the user, the product, and the version of the documentation are all entered into the index file (step 310). Afterward, the stop word file and synonym file, if indicated, are located and copied into memory (step 312). Note that if a synonym file is not indicated, a default synonym file will be used. The language in which the documentation is to be presented to a user may be used to identify the default synonym file to be used.

If a synonym file is indicated then a check is made to determine whether the synonym file contains words in the same language as the language in which the documentation is to be presented to the user (step 316). If not, an error is logged into the log file (step 318). If so, each HTML file that makes up the product documentation is parsed for unique words (step 320). Each unique word found is entered into the index file (step 322). Then, the synonym file is checked to determine whether there exists a synonym or synonyms for the unique word (step 324). All synonyms, titles and links to the documents in which the word is found are entered into the index file (step 326). Finally, the ranking score for each document that contains the unique word is calculated and entered into the index file (step 328) and the process ends (step 330).

### B. The Index File

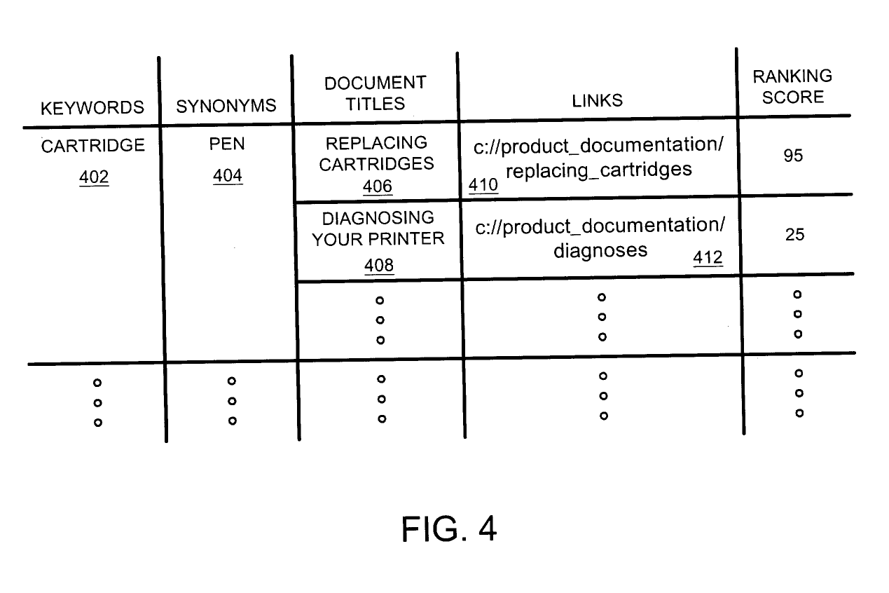

FIG. 4 depicts a sample index file of one embodiment of the present invention. The index file may be regarded as a cross-referencing table. Referring to FIGS. 1-2 along with FIG. 4, as mentioned above, the index file 126 contains all unique words or keywords, their synonyms, the title of the document in which they are found, the links to the document and a ranking of each document.

In this exemplary index file 126, which is presented for illustrative purposes, cartridge 402 is a unique word, a synonym to the word cartridge may be “PEN” 404. Two of the documents in which the word cartridge was found are “REPLACING CARTRIDGES” 406 and “DIAGNOSING YOUR PRINTER 408. The link and ranking score of the document REPLACING CARTRIDGES are c://product_documentation/replacing_cartridges 410 and 95, respectively. Whereas, the link and ranking score of the document DIAGNOSING YOUR PRINTER are c://product_documentation/diagnosis 412 and 25, respectively. As mentioned above, this index file 126, as well as the product documentation, is placed onto a circulation media, such as a CD-ROM, to be given to a product purchaser/user in this embodiment.

### C. Searches

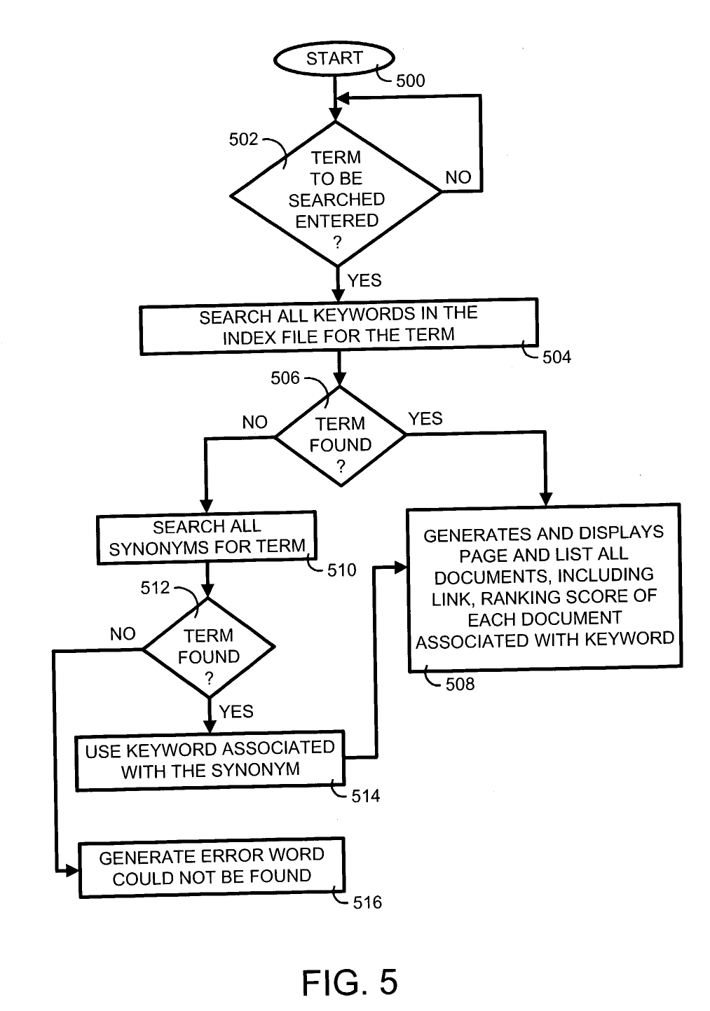

FIG. 5 shows a flow diagram of a process that may be used to conduct a search according to one embodiment of the present invention. Referring to FIG. 1A and FIG. 2 along with FIG. 5, when the user 130 is interested in a subject matter, in the embodiment of the present invention that uses a CD-ROM as the distribution medium, the user may load the product documentation 110 into computer readable memory and invoke the search engine feature 108. After doing so, the user 130 enters a term or phrase relating to the subject matter in question

As an example, if the product is an inkjet printer and the user wants to replace one of the inkjet cartridges, the user can enter the word “pen” in order to search for the section of the documentation 110 that provides information on the ink cartridges. In this example, if the term “pen” is synonymously associated with the term “cartridge”, the search returns at least two documents in which the keyword “cartridge” is found. Specifically, the search result may include both the title of the two documents (e.g., “REPLACING CARTRIDGES” and “DIAGNOSING YOUR PRINTER”) and the links to the documents. The search result may also indicate the likelihood (e.g., ranking score) of each document being the document that contains the information that is of interest to the user.

In general, the process starts when the user invokes the search feature of the product documentation (step 500). It is then determined whether the search term is properly entered (step 502). Next, when a term is entered, all keywords in the index file are searched for the term (step 504). The engine then determines whether the term is found (step 506). If the term is found, a page is generated and displayed to the user 130 with a listing of all the documents that contain the term (step 508). The listing preferably includes the titles of the documents, the links to the documents and ranking score of each document.

If the term is not found in the list of keywords in the index, then the list of synonyms is searched for the term (step 510). The engine then determines whether the term is found (step 512). If the term is found, the keyword whose synonym is the term entered will be used (step 514). Again, titles of all documents that contain the keyword are listed in a page along with their links and their ranking score and displayed to the user 130 (step 508). If the term is not found in either the list of keywords or the list of synonyms, an error may be generated and displayed to the user 130 (step 516). The process ends when the user exits the search feature.

### III. Conclusion

The foregoing has described the principles, preferred embodiments and modes of operation of the present invention. However, the invention should not be construed as being limited to the particular embodiments discussed. Thus, the above-described embodiments should be regarded as illustrative rather than restrictive, and it should be appreciated that variations may be made in those embodiments by anyone skilled in the art without departing from the scope of the present invention as defined by the following claims.

What is claimed is:

1. A method of providing a user-friendly search system with a document on a distribution medium comprising:
parsing the document for keywords that are to be included in an index of words in the document;
associating each keyword with at least one synonym, the synonym being at lease one common word used by users that relates to the keyword; and
incorporating the keyword and the at least one synonym in the search system.

2. The method of claim 1 further comprising associating with the keyword a link for each page of the document where the keyword is located.

3. The method of claim 2 further comprising ranking each page associated with the keyword for its importance to a subject matter.

4. The method of claim 3 wherein the ranking step includes assigning a different number for each different location of the keyword in the document.

5. The method of claim 4 wherein the different locations include a meta-tag, title and text of each page of the document.

6. The method of claim 1 wherein the distribution medium is a CD-ROM.

7. The method of claim 1 wherein the distribution medium is the Internet.

8. A method of providing a user-friendly search system with product documentation, the method comprising:
providing a portable storage medium that stores the product documentation;
receiving, by a computer, user input that describes either a keyword or a pre-determined synonym of the keyword;
responding, by the computer, to the input by accessing an index in order to identify at least one location in the documentation;
displaying, by the computer, a selectable link to the at least one location; and
wherein the index indicates that both the keyword and the synonym are associated with the at least one location.

9. The method of claim 8, wherein the index is also stored on the portable storage medium.

10. The method of claim 9 wherein a search engine is also stored on the portable storage medium; and wherein the search engine is executable by the computer to perform the receiving step and the responding step.

11. The method of claim 10, wherein the displaying step further includes displaying an indication of the likelihood that the at least one location is of interest to the user.

12. A computer program product on a portable computer readable medium for providing a search system on a computer comprising:
a document;
an index that includes keywords, associated synonyms and associated pointers to locations in the document; and
a search engine, executable by a computer, to:
a) receive input from a user, the input being a keyword or a synonym associated with the keyword,
b) respond to the input by accessing the index to determine one or more locations in the document, and
c) display selectable links to those locations.

13. The computer program product of claim 12 wherein the search engine displays a link for each page of the document where the keyword is located.

14. The computer program product of claim 13 wherein each keyword and synonym is associated with a predefined number of points related to at least one of its importance to a predefined subject matter and its location in the document.

15. The computer program product of claim 14 wherein the search engine uses the points given to each keyword and synonym to rank each page with the keywords and synonyms as an estimate of importance of a subject matter of that page.

16. An apparatus for providing a user-friendly search system with a document comprising:
means for storing a document on a portable medium;
means for storing an index file on the portable medium, the index file including keywords that relate to subject matters in the document; and
means for storing a search feature on the portable medium that is executable on a computer that associates each keyword with at least one synonym in the index file, the synonym being a word that may be used by a user instead of the keyword for searching the document for a subject matter.

17. The apparatus of claim 16 further comprising means for associating each keyword and synonym with a predefined number of points related to its importance to a predefined subject matter.

18. The apparatus of claim 17 further comprising means for using the points given to each keyword and synonym to rank each page with the keywords and synonyms as an estimate of importance of a subject matter of that page.

19. The apparatus of claim 17 wherein means for associating each keyword and synonym with a predefined number of points includes assigning a point number based on a location of each keyword and synonym in the document.

20. A search system for a computer for searching a document comprising:
an index file that includes keywords, associated synonyms and associated pointers to locations in the document; and
a search engine, executable by the computer, to:
(a) receive input from a user, the input being a synonym of a keyword,
(b) respond to the input by accessing the index to identify one or more locations in the document that includes the keyword; and
(c) display selectable links to the identified locations.

21. The search system of claim 20, wherein the index file and the search engine are all stored on a portable storage medium

22. The search system of claim 21, wherein the document is also stored on the portable storage medium.

23. The search system of claim 20 wherein the index file and the search engine reside on a server that is located remotely from the computer and networked to the computer.

24. The search system of claim 23 wherein the server and the computer are networked together via the Internet.
